(19) United States
(12) Patent Application Publication
(10) Pub. No.: US 2016/0335328 A1
(43) Pub. Date: Nov. 17, 2016

(54) System and Methods for Retrieving Content Based on Context in a Mobile Environment

(71) Applicant: Lexmark International Technology, Sarl, Meyrin (CH)

(72) Inventors: Donald Emmett Lampert, Roeland Park, KS (US); Brandon Michael Petty, Kansas City, MO (US)

(21) Appl. No.: 15/089,008

(22) Filed: Apr. 1, 2016

Related U.S. Application Data
(60) Provisional application No. 62/150,091, filed on Apr. 20, 2015.

(51) Int. Cl. G06F 17/30; G06F 3/0481; H04W 4/00

(52) U.S. Cl. CPC G06F 17/30554; H04W 4/003; G06F 17/3056; G06F 3/0481

(57) ABSTRACT

A system and methods for providing related content to a user accessing a first application configured to be monitored in a mobile device that includes detecting if the first application is specified in a defined configuration. If the first application is determined to be specified in the defined configuration, data may be retrieved from a predetermined context. Using the retrieved data, content related to the retrieved data may be automatically searched for in a second application, and the searching is performed while the first application is being accessed by the user in the mobile device. The search results are received from the second application; and the user is notified of the search results. The predetermined context may include an identity associated with the first application, a page of the first application, a data field of the first application, and/or a system service of the mobile device.

### CROSS REFERENCES TO RELATED APPLICATIONS

The present application is related to and claims priority under 35 U.S.C. 119(e) from U.S. provisional application No. 62/150,091, filed Apr. 20, 2015 entitled, “System and Methods for Searching Content Based on Context in a Mobile Environment,” the content of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present invention relates generally to a system and methods of retrieving content from multiple applications and, more particularly, to retrieving content related to context information in a mobile environment.

2. Description of the Related Art

With the pervasive use of mobile devices today, accessing information through mobile applications in mobile devices is becoming increasingly important to the way people handle and work with substantial amounts of data. Today, users are expected to have access to information in their mobile devices as though they are sitting in their home or office in front of their computers or workstations. However, with the countless mobile applications available, and each mobile application capable of handling seemingly infinite amounts of data, a mobile user may be overwhelmed when trying to locate or retrieve information they need or desire. Because relevant information may be spread out across multiple applications, the user may need to switch back and forth between applications in order to search each application for the relevant data, which may be inefficient, exhausting and/or time-consuming.

Accordingly, there is a need for a system and methods for monitoring a mobile device for a predetermined context and providing results from multiple applications or services relevant to the found context information.

### SUMMARY

From the foregoing disclosure and the following detailed description of various example embodiments, it will be apparent to those skilled in the art that the present disclosure provides a significant advance in the art of methods for retrieving relevant content from mobile applications based on context information from a first mobile application.

In the present disclosure a system and methods for providing related content to a user accessing a first application in a mobile device are disclosed. One example method for providing related content to a user accessing a first application in a mobile device includes detecting if the first application is specified in a defined configuration; upon positive determination of the detecting, retrieving data from a predetermined context; using the retrieved data, automatically searching for content related to the retrieved data from a second application on the mobile device, the searching performed while the first application is being accessed by the user on the mobile device; receiving a result of the searching from the second application; and notifying the user of the search result. At least one of the detecting, the retrieving, the automatically searching, the receiving and the notifying is performed by a monitoring application installed on the mobile device. The predetermined context may include an identity associated with the first application, a page of the first application, a data field of the first application, and/or a system service of the mobile device.

Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows one example system for use in retrieving content in context in a mobile environment.

FIG. 2 shows one example embodiment of an example application having context information.

FIG. 3 shows one example method of retrieving content in context in a mobile environment.

FIG. 4 shows one example unobtrusive notification that may be presented to the user while in the accessed application.

FIG. 5 shows one example notifications interface that may be accessed by the user conveniently from the accessed application.

FIG. 6 shows one example content display that summarizes content related to the context information from the application being accessed.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes.

Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and ^{an} herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

The blocks of the diagrams support combinations of means for performing the specified functions, combinations of steps for performing the specified functions and program instruction means for performing the specified functions. It will be further understood that each block of the diagrams, and combinations of blocks in the diagrams, respectively, may be implemented by special purpose hardware-based computer systems that perform the specified functions or steps, or combinations of special purpose hardware and computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Disclosed are an example system and example methods for retrieving content based on context in a mobile environment. In one example embodiment, the method includes installing a monitoring application in the mobile device that receives events when a user is interacting with a specified application in the mobile device. During operation, the monitoring application starts monitoring a specified application for context information. When the monitoring application detects the existence of context information, it may retrieve the context information from the specified application and use the retrieved context information to search content of other applications in the mobile device that is related to the retrieved context information. The monitoring application may then provide unobtrusive search result notifications to the user. In some example embodiments, the searching of content from other applications is performed every time the context information in the predetermined context has been detected as having changed. In other example embodiments, the searching may occur at predetermined intervals.

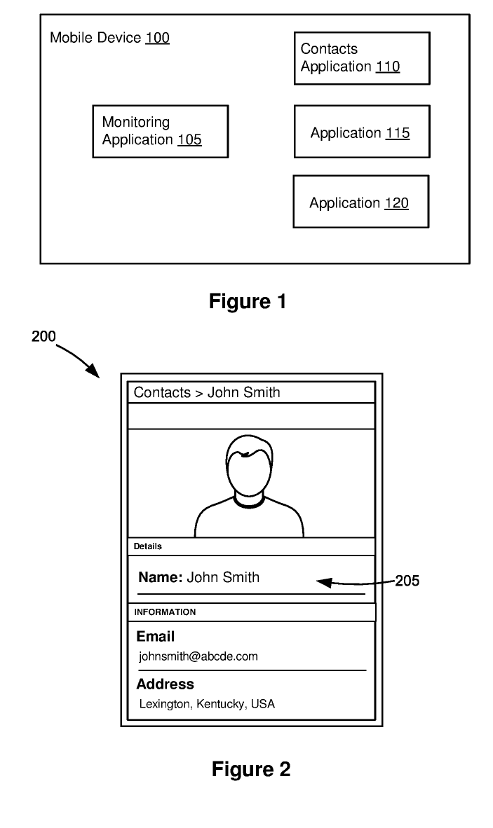

FIG. 1 shows one example system or mobile device for use in retrieving content in context in a mobile environment. Mobile device 100 includes one or more applications 105-120 installed on mobile device 100. Mobile device 100 may be any computing device capable of executing applications thereon such as, for example, a mobile phone, laptop, or a tablet computer. Mobile device 100 may include a processor (not shown) and a computer-readable storage medium (not shown), such as a random access memory (RAM), coupled to the processor. The processor may execute computer-executable program instructions stored in the memory. Computer-executable program instructions may include a set of instructions for executing functions of the one or more applications 105-120 installed on mobile device 100.

Monitoring application 105 may be a mobile application installed on mobile device 100 that may monitor other applications 110-120 installed on mobile device 100 for context information at a predetermined context. In some example embodiments, the predetermined context may be a specific application or applications 110-120. In other example embodiments, the predetermined context may refer to a specific field or fields within one or more applications 110-120. In still other example embodiments, the predetermined context may be a specified graphical interface screen or screen (i.e., page or pages) within one or more applications 110-120.

In yet other example embodiments, the predetermined context may be certain information or data automatically provided by a system service, such as a location from a global positioning system service; a date from a calendar service; or a time from a clock service, of mobile device 100.

Context information may refer to information that is relevant to an object organized and accessed at a predetermined context. In many example embodiments, context information may be stored at the predetermined context. Using context information found at the predetermined context, monitoring application 105 may search and provide results from other applications that are relevant to the context information. Monitoring application 105 may receive events when the user of mobile device 100 is interacting with one or more specified applications, and retrieve content from the application being accessed when such application meets a set of criteria or predetermined context. In some example embodiments, the retrieved content or results may then be displayed in a new window that pops up or is visible on the user interface of mobile device 100.

In other example embodiments, monitoring application 105 may be configured to notify the user of mobile device 100 of the results in one or more unobtrusive methods. For example, the retrieved content may be displayed in a status bar or notifications bar of mobile device 100, or in an indicator indicating that relevant content has been retrieved may be displayed in a status window (such as where connectivity strength or battery life remaining are typically found). In another example embodiment, monitoring application 105 may transmit the results or a notification that results have been received to a device located remotely from and communicatively coupled to mobile device 100. Such remote device may be a second mobile device or a watch capable of communicating with mobile device 100 via a wired or wireless connection, such as Bluetooth or Wi-Fi. Such transmissions may be in addition to or in lieu of notifications within mobile device 100.

Application 110 may be any software or another computer program installed on mobile device 100 which is executable by a processor and can be stored on a computer-readable media. In some example embodiments, application 110 may refer to firmware and/or a combination of software and firmware. In some other example embodiments, application 110 may be executed on the web or over a network. Application 110 may process, organize, manipulate, store, generate, display, and/or otherwise render context information that can be used by application 105 to retrieve content from other applications 115-120.

For illustrative purposes, application 110 may be a “Contacts” application installed on mobile device 100 that includes a directory or a repository which stores and organizes contacts along with accompanying contact details. In one example configuration of monitoring application 105, the predetermined context of Contacts application 110 may be set to a details contact page of an individual. When a particular individual's contact page is accessed by the user, such individual's contact details may be automatically retrieved by application 105 and set as the context information, as will be described in greater detail below. In this example, context information may include, but is not limited to, the individual's name, mobile phone number, e-mail address, home phone number, business address, and/or birthday. FIG. 2 shows one example embodiment of an individual's details contact page 200 from Contacts application 110. In this example embodiment, a Name field 205 may be set as the predetermined context, and the context information contained in the predetermined context is the individual's name (in this example embodiment, “John Smith”). The term “John Smith” may then be used by application 105 to search for related content in other applications in mobile device 100, as will be discussed in greater detail below.

Referring back to FIG. 1, monitoring application 105 may be configured to monitor all applications running on mobile device 100. When a user interaction occurs for any application running on mobile device 100, monitoring application 105 may be notified. Monitoring application 105 may then determine whether the application with which the interaction occurs is identified in a defined configuration. In some other example aspects, monitoring application 105 may be configured to monitor only specific applications such as, for example, Contacts application 110, for interaction by a user of mobile device 100.

Monitoring application 105 may include one or more settings that allow a manufacturer, service provider and/or user of mobile device 100 to set which of the other applications installed on mobile device 100 will be monitored and to configure the predetermined context for the applications to be monitored. In some alternative example embodiments, a manufacturer, service provider and/or administrator of monitoring application 105 may configure the monitoring settings and/or the predetermined context.

If the application interacted with by a user is specified in the defined configuration, the actions specified in the defined configuration, which are associated with the specified application, may be performed. If the application interacted with by a user is not specified in the defined configuration, no action is performed (i.e., the interaction is ignored or filtered out by monitoring application 105). In some other example aspects where the application interacted with and/or the application with its predetermined contexts is not found in the defined configuration, monitoring application 105 may cause a filtering to occur, which may result in limiting what data monitoring application 105 passes on for subsequent searching.

For example, monitoring application 105 may be configured to automatically monitor or detect Contacts application 110 for a particular event occurring in mobile device 100. An event may be any event performed as a result of user interaction with mobile device 100. For example, when a user selects application 115 or 120 to be activated or executed, the event is the displaying of the selected application 115 or 120 to the user through the user interface of mobile device 100. In some example embodiments, events may refer to events triggered by mobile device sensors or system services, such as, for example, location services, accessibility helper services, or date and time services. Events may include, but are not limited to, a user's access of Contacts application 110 or a particular page within Contacts application 110, a user's modification, creation, or deletion of data (i.e., field values) within Contacts application 110, and/or other user interactions.

Continuing with the example of a contact details page of an individual as the predetermined context for Contacts application 110, the event for which monitoring application 105 is listening and which triggers the setting of the predetermined context is the accessing of any individual's contact details page. In operation, if the initial screen of

Contacts application 110 is a listing of contact names, and a user activates or opens Contacts application 110, no action is taken or triggered on monitoring application 110. However, once a user selects a contact details page for a particular individual (e.g., “John Smith”), monitoring application 105 detects such action and may retrieve and/or set the predetermined context to the value(s) contained in the active contact details page (i.e., “John Smith” in this example).

User interactions may refer to an event in mobile device 100 wherein the user accesses Contacts application 110 such that a window of Contacts application 110 is displayed in the user interface of mobile device 100 as shown in FIG. 2. When a user interaction occurs for Contacts application 110 running on mobile device 100, monitoring application 105 may be notified. Monitoring application 105 may then determine whether Contacts application 110 is identified in the defined configuration. Since, in this example embodiment, Contacts application 110 is specified in the defined configuration, context information located at the predetermined context may be retrieved from Contacts application 110. If also identified or specified in the defined configuration, listening for changes to a specific field such as, for example, the Name field 205, may also begin when a specific page of Contacts application 110 is being accessed. It will be known in the art that applications installed on mobile device 100 may include one or more pages or context.

Once a context information is set and/or retrieved, the context information may be utilized by monitoring application 105 to retrieve content related to the context information from one or more applications 115, 120. Applications 115 and 120 may store content that is searchable using one or more keywords such as, for example, an individual's name, an individual's contact number, and the like. Application 115 does not need to be communicatively coupled to or otherwise interact with example Contacts application 110 or application 120 (i.e., applications 110-120 may be independent of each other). In this example embodiment, applications 115 and 120 may be repositories for content, and some of the content may be associated with contacts stored in Contacts application 110. Example application 115 may be a “Documents” application installed on mobile device 100 that includes a directory or a repository which stores and organizes documents, folders, and/or other content along with accompanying content details. Example application 120 may be a “Tasks” application installed on mobile device 100 that includes a directory or a repository which stores and organizes tasks, action items, and/or other assignments along with accompanying task details.

In one example embodiment, monitoring application 105 and applications 115 and 120 may run in background while Contacts application 110 is being accessed such that when a user accesses and interacts with Contacts application 110, monitoring application 105 may retrieve the context information without user intervention and/or unobtrusively from Contacts application 110 and utilize the retrieved context information to search for content from applications 115 and/or 120. Since the retrieving of the context information is performed in the background while Contacts application 110 is displayed in the user interface of mobile device 100, there is no need for the user to exit Contacts application 110 or to switch to application 105 in order to perform the retrieving of context information. The searching for content associated with the retrieved context information may also be performed in the background such that there is no need for the user to switch to applications 115 or 120 in order to perform the searching of content related to the context information.

In some alternative example embodiments, applications 115 and/or 120 may be installed on a device or devices communicatively coupled to mobile device 100. For example, applications 115 and/or 120 may be web or other applications stored on a remote server or other mobile device, such as a tablet computer or a watch, and monitoring application 105 may search for data from applications 115 and/or 120 via a wired or wireless connection, such as Bluetooth or Wi-Fi.

In one example embodiment, applications 115 and/or 120 may be specified in one or more configuration settings of monitoring application 105 to be the applications from which relevant content related to the context information (i.e., value(s) in the predetermined context) of application 110 may be retrieved. For example, upon installation of monitoring application 105 in mobile device 100, the user may configure from which applications 110-120 to search for content related to the context information.

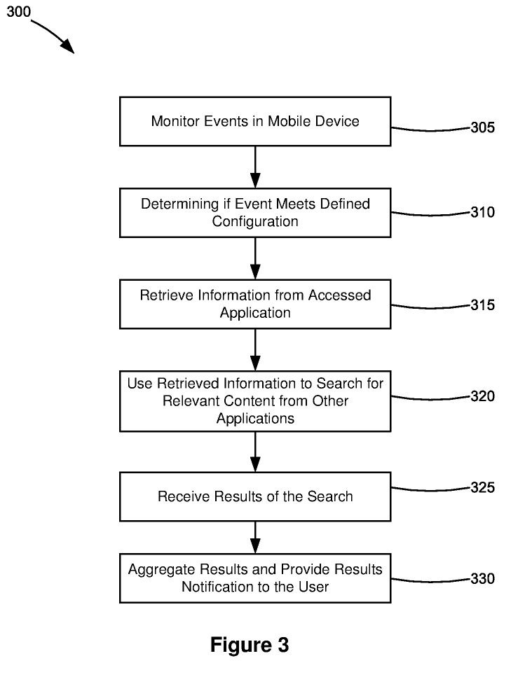

FIG. 3 shows one example method 300 of retrieving content in context in a mobile environment. Example method 300 may be performed on mobile device 100 using a monitoring application 105 on mobile device 100 to monitor events or actions occurring on mobile device 100 that meet a defined configuration, to retrieve context information from a predetermined context in another application such as Contacts application 110, and/or search for content related to the context information from one or more applications 115-120 in mobile device 100.

At block 305, monitoring application 105 may monitor events occurring in mobile device 100. In some example embodiments, event monitoring occurs continuously in the background of mobile device 100 as long as application 105 is listening for events. In other example embodiments, event monitoring may be programmed or otherwise set to occur at predetermined time periods and/or at certain intervals. It will be appreciated by those skilled in the art that other parameters may be used to determine the frequency and length of monitoring. For example, a particular day of the week and/or time may be set to restrict the monitoring of applications 110-120 to only certain day(s) and/or times of the day. In some example aspects, location services may be used as the monitoring parameters. For example, a particular location may be programmed or otherwise set to restrict the monitoring of applications 110-120 only to instances when mobile device 100 is in a specific location. Monitoring parameters may be defined in a configuration file.

At block 310, monitoring application 105 determines if the event that occurred or is detected in mobile device 100 meets a defined configuration. The defined configuration, which may be stored as a configuration file, includes any predetermined context(s) for which monitoring application 105 will monitor. The defined configuration may also include a list of applications 110-120 from which content related to the context information may be searched or retrieved. In some example aspects, the defined configuration may be hardcoded into monitoring application 105 by the creator of monitoring application 105. In other example aspects, a distributor, user or administrator of monitoring application 105 or mobile device 100 may set or define the criterion or criteria for which to monitor.

If an event is detected or raised, monitoring application 105 may automatically collect information from the application being accessed or executed (e.g., application 110, application 115 or application 120) at block 315. The collected information may include, for example, the name of the application or other identifier that may be used in determining whether a criterion in a defined configuration has been matched or met.

If the event meets the defined configuration, monitoring application 105 may determine if the raised event includes information that meets a predetermined context of the defined configuration.

In one example embodiment, the predetermined context may be a Hypertext Markup Language (HTML) tag or HTML user interface (UI) element, container, or variable that contains information, data or value that may be used by another application to locate a record. The HTML elements may be components of an HTML document and the information, data or value may include other HTML elements, text, and the like. The data in the configured field may be any data type capable of being recognized by an application such as, for example, a label, a string identifier, a number identifier, or any string of text.

In another example embodiment, the predetermined context may be an Extensible Markup Language (XML) tag or corresponding user interface (UI) element, container, or variable that contains information, data or value that may be used by another application to locate a record. The XML elements may be components of an XML document and the information, data or value may include other XML elements, text, and the like. The XML element may be referenced via an XML Path Language (XPath) location path. The data in the configured field may be any data type capable of being recognized by an application such as, for example, a label, a string identifier, a number identifier, or any string of text.

In some example aspects, such as where an application has multiple user interfaces or pages, a specific interface from where information can be retrieved may be set in the defined configuration of monitoring application 105. In such example aspects, determining if the event meets the defined configuration may include verifying that the user interface or page currently being accessed by a user (i.e., the “active” interface or page) is the user interface of the application specifically defined as a predetermined context.

At block 320, monitoring application 105 may use the retrieved data or context information from the accessed application to search for relevant content in any number of other applications (e.g., applications 115, 120 if the accessed application is Contacts application 110) executing on mobile device 100 and/or other applications communicatively connected to mobile device 100.

Continuing with the example of Contacts application 110 being the accessed application, applications 115 and 120 may be independently or asynchronously searched for content relevant or related to the context information, and relevant search results may be sent back to monitoring application 105 at block 325. Relevant search results or related content may include content identified as matching or relating to the context information. Relevant search results or related content may be obtained automatically, without the user initiating the search and/or retrieval, on applications 115 and/or 120 using context information which is currently being accessed in Contacts application 110.

The returning of the search results to monitoring application 105 from other applications (applications 115 and 120 in this example) may be performed in the background while the user is accessing Contacts application 110. The advanced or preemptive retrieval of relevant content enables the applications running on mobile device 100 to aggregate the retrieved content automatically in the background. At block 330, the results of the search from applications 115 and 120 may be aggregated and then displayed or made otherwise accessible to the user, thereby allowing the user to access the related content without performing a manual search in any of the other applications 115, 120.

In some example aspects, monitoring application 105 may also provide a notification to the mobile user regarding the identification or availability of results of the search for content related to the context information. The notification message sent at block 330 may include a universal resource locator (URL) to the listing of search results, and by activating or clicking on the URL, the user may be directed to a display of the search results, from which the user can select the related content of interest.

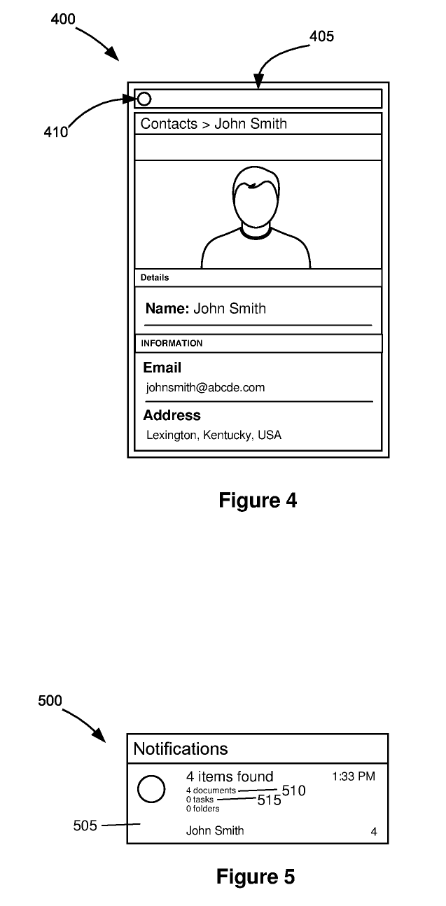

In some example embodiments, the providing of notification to the user may be performed in unobtrusive manner using a notification layer in mobile device 100. FIG. 4 shows one example unobtrusive notification. The providing of notification may include displaying at a portion of the graphical interface of mobile device 100, as indicated by graphical interface element 405, a notice indicating the availability of the results of the search, as indicated by notification 410. The displaying may be performed while the user is still accessing Contacts application 110 and may be performed without the user exiting Contacts application 110.

In other example embodiments, the notifications may be message sent via text or e-mail. Other unobtrusive methods of providing notification to the user while the user is accessing application 110 will be known in the art. In some alternative example embodiments, a second mobile device, such as a smart watch, may be communicatively connected to mobile device 100. In such example embodiments, notifications of search results may be sent to the second mobile device. Such notifications may occur through text or e-mail messages, vibrations, lights, background changes or other known methods.

Referring back to Contacts application 110 as an example for illustrative purposes, if Contacts application 110 has been set in monitoring application 105 as an application to be monitored, a user may select or depress an icon or other identifier associated with Contacts application 110 on mobile device 100 to access or activate Contacts application 110, and the activation of Contacts application 110 may be the event raised to monitoring application 105.

The raised event may then return the application name or identifier associated with Contacts application 110 to monitoring application 105 to indicate that Contacts application 110 is being accessed.

Upon access of Contacts application 110, monitoring application 105 may also collect, receive and/or retrieve context information associated with Contacts application 110 from accessed Contacts application 110. The context information may be information from a field in Contacts application 110 corresponding to the correct predetermined context (i.e., the field identified in the defined configuration file from which to retrieve the information). The context information from the predetermined context may be automatically forwarded to application 105 upon detection of a context match. For example, the collected information may include, for example, an identifier of the active screen or page and/or fields contained thereon when Contacts application 110 is accessed.

In some example aspects, the act of accessing Contacts application 110 may be the predetermined context defined in the defined configuration such that when a user accesses Contacts application 110, monitoring application 105 automatically determines that Contacts application 105 matches the predetermined context.

In other example aspects, the predetermined context in Contacts application 110 may be set to an individual's contact details page (e.g., John Smith's contact details page shown in FIG. 2). In such example aspects, an individual's contact details page, not a listing of contact names, must be accessed by a user before information from the individual's contact page (i.e., context information) may be retrieved. In such example embodiment, if the main or index page of Contacts application 110 is the initial page accessed (i.e., “active” page) upon invoking Contacts application 110, no information retrieval will be performed unless the main or index page of Contacts application 110 is also specified in the defined configuration.

Upon receiving a notification that Contacts application 110 is being accessed or executed in mobile device 100, monitoring application 105 may determine if a specific context in Contacts application 110 is being accessed (i.e., the event meets the criterion set in the defined configuration). Using the above example, if it is determined that the individual contact page is accessed, information retrieval may be performed on such page.

For example, Name field 205 of page 200 in Contacts application 110 in FIG. 2 may be the predetermined context, and monitoring application 105 may retrieve the data from Name field 205 (shown in FIG. 2 as “John Smith”) when an individual contact page is accessed by the user. The retrieval of this context information (“John Smith” in this example) may be performed in the background while the user is accessing Contacts application 110 such that the user may use Contacts application 110 seamlessly and without interruption. Other defined configurations may include other information regarding the event, as will be known in the art.

Monitoring application 105 may then use the retrieved data or context information (“John Smith” in this example) from the accessed application (e.g., Contacts application 110 in this example) as the search criteria or query to search for and identify matching or otherwise relevant content in any number of other applications (e.g., applications 115 and/or 120) executing on mobile device 100 and/or other applications communicatively connected to mobile device 100.

FIG. 5 shows one example notifications interface 500 that may be accessed by the user conveniently from Contacts application 110. Notifications interface 500 may display or show a summary 505 of the results of the background search performed by monitoring application 105 for content related to the context information. In this example, four documents related to the “John Smith” contact have been identified or found to be stored in example Documents application 115, as indicated by notification 510 in notifications interface 500. Example application 120, which may be a repository for tasks or action items, may return zero tasks related to “John Smith”, and this result may be displayed accordingly as notification 515 in notifications interface 500.

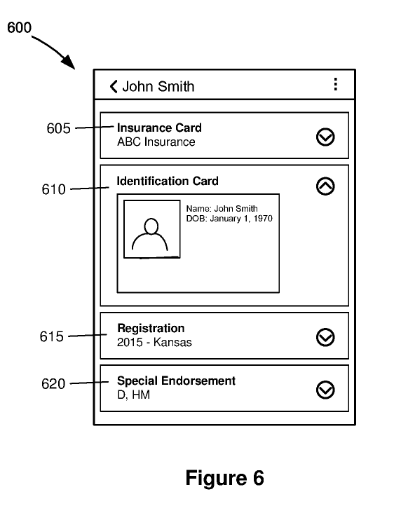

In some example aspects, a user may select or click on notifications 510, 515 to view the actual search results or information associated with the results, such as the identifier or title of a document or task. Clicking on or selecting a particular identifier from notification 510, 515 may allow the user to access the actual content directly from the application (e.g., application 115 or 120) which contributed the matching search result. In other example aspects, clicking on or otherwise activating summary 505 may allow the user to access a more detailed summary within application 105, such as that shown in FIG. 6.

FIG. 6 shows one example embodiment of a mobile device interface 600 displaying a more detailed summary of content from other applications (e.g., applications 115 and/or 120 in this example) that was found or otherwise identified by a search query for items related to the “John Smith” context information from Contacts application 110. Example interface 600 may be accessed by clicking on notification 510. The example content identified resulting from the automatic search performed using the search query “John Smith” while the user was accessing the John Smith contact page 200 includes an Insurance Card 605, an Identification Card 610, Registration information 615 and Special Endorsement information 620. Such results are provided to the user without the user performing an explicit search for relevant documents in separate Document application 115, which provides a smart, fast and efficient method for providing the user a list of related content even before the user may have discovered the need to search for the content.

In a second example embodiment, the search for related content may automatically, without user intervention, react to changes in the context of the application being monitored. In such an example embodiment, changes in an accessed application (e.g., Contacts application 110) may be listened for by monitoring application 105, and new context information may be set based upon the changes. A new search may be performed when a change in context is detected. Monitoring changes in the accessed application allows monitoring application 105 to make context-sensitive searches and retrieve related content from another application (e.g., applications 115 and/or 120) based on the context of the application as it is being accessed by the user (i.e., in real time). Such real-time performance of searches eliminates the need to manually update the related searches to reflect the current context of the accessed application, thereby providing the user of the mobile device with the updated related content for every context information found in each predetermined context of the accessed application 110.

Referring back to Contacts application 110 as an example for illustrative purposes,

Monitoring application 105 may continuously monitor the activity (i.e., what actions are occurring or taking place and/or which interface is active) in Contacts application 110 to determine if the user has accessed a different contact, modified information related to a contact, added a new contact, deleted a contact or information related to a particular contact and/or looked up the information of a different contact . Any of such action may signify a contextual change in Contacts application 110. For example, if the user accessed a new contact, Jane Smith, the context change to the data in the Name field 205 (“John Smith” to “Jane Smith”) may be detected, and “Jane Smith” may be automatically forwarded to monitoring application 105 and set as the new context information. Such change in context may also trigger a new search query for content related to the new context information “Jane Smith.” Aggregation and notification of the results, as discussed above, may be performed for every search invoked by the changes in the event performed on Contacts application 110. This continuous monitoring of changes in the Contacts application 110 ensures that the user will be given context-sensitive content search results for any and all contacts that the user may access while using Contacts application 110 at any given time.

In some example aspects, any stored context information remains stored until overwritten as a result of a context change. In other example aspects, any stored context information may be automatically deleted immediately or at some predetermined interval when activities in mobile device 100 fail to trigger a replacement of the context information. For example, continuing with above example, “John Smith” may be deleted as the stored context information if a user goes or visits the list of contacts interface or activates a different application running on mobile device 100.

It will be understood that the example applications described herein are illustrative and should not be considered limiting. It will be appreciated that the actions described and shown in the example flowcharts may be carried out or performed in any suitable order. It will also be appreciated that not all of the actions described in this disclosure need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which this disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for providing related content to a user accessing a first application in a mobile device, comprising:
detecting if the first application is specified in a defined configuration;
upon positive determination of the detecting, retrieving data from a predetermined context;
using the retrieved data, automatically searching for content related to the retrieved data from a second application on the mobile device, the searching performed while the first application is being accessed by the user in the mobile device;
receiving a result of the searching from the second application; and
notifying the user of the search result,
wherein at least one of the detecting, the retrieving, the automatically searching, the receiving and the notifying is performed by a monitoring application installed on the mobile device.

2. The method of claim 1, wherein the notifying the user of the result includes notifying the user of the result through a notification interface displayed on the mobile device.

3. The method of claim 1, wherein the notifying the user of the result includes notifying the user of the result through a notification interface remote from the mobile device.

4. The method of claim 1, wherein the automatically searching for content is performed using the retrieved data as a search query for searching content related to the retrieved data.

5. The method of claim 1, wherein the predetermined context includes at least one of an identity associated with the first application, a page of the first application, a data field of the first application, and a system service of the mobile device.

6. A method for providing related content to a user accessing a first application in a mobile device, comprising:
receiving an event if the first application is being accessed by the user using the mobile device;
in response to the receiving the event, retrieving data from a predetermined context;
using the retrieved data, automatically searching for content related to the retrieved data in a second application on the mobile device, the searching performed while the first application is being accessed by the user;
receiving a result of the searching from the second application; and
providing a notification relating to the result of the searching from the second application.

7. The method of claim 6, wherein the receiving the event if the first application is being accessed by the user using the mobile device includes receiving the event if the first application is being displayed in an interface of the mobile device.

8. The method of claim 6, wherein the retrieving the data includes retrieving data from a predetermined context.

9. The method of claim 6, further comprising continuously monitoring the data at the predetermined context.

10. The method of claim 9, wherein if a change in the data being continuously monitored is detected, automatically searching the second application for content related to the changed data at the predetermined context.

11. The method of claim 6, wherein the automatically searching for content related to the retrieved data from the second application in the mobile device is performed without exiting the first application.

12. The method of claim 6, wherein the predetermined context includes at least one of a page of the first application, a data field of the first application, and a system service of the mobile device.

13. A mobile computing device having a non-transitory computer readable storage medium having one or more instructions for providing context-sensitive content for a first application being accessed by a user in the mobile computing device, the one or more instructions comprising:
receiving an event if the first application is being accessed by the user using the mobile device;
in response to the receiving the event, continuously monitoring the first application to determine context of the first application;
performing a search based on the context of the first application by:
retrieving a first data from the first application and automatically searching a second application for content related to the first data retrieved from the first application;
if the continuously monitoring of the first application indicates a change in the context or within the context of the first application, retrieving a second data from the first application and automatically performing another search for content related to the second data;
receiving a result of the search performed based on the context information of the first application; and
notifying the user of the result of the search performed based on the context information of the first application.

14. The mobile computing device of claim 13, wherein the one or more instructions for continuously monitoring the first application to determine context of the first application includes continuously monitoring data from the application.

15. The mobile computing device of claim 13, wherein the receiving the event if the first application is being accessed by the user using the mobile device includes receiving the event if the first application is being displayed in an interface of the mobile device.

16. The mobile computing device of claim 13, wherein the automatically searching the second application for content related to at least one of the first and the second data is performed while the user is accessing the first application.

17. The mobile computing device of claim 13, wherein the automatically searching the second application for content related to at least one of the first and the second includes searching a remote server communicatively connected with the mobile device for content.

18. The mobile computing device of claim 13, wherein the automatically searching the second application for content related to at least one of the first and the second data includes searching at least one application installed on the mobile device for content.

19. The mobile computing device of claim 13, wherein the notifying the user of the result of the search includes displaying a list of the content that were found to be related to at least one of the first and the second data based on the context of the first application.

20. The mobile computing device of claim 19, wherein the displaying the list of the content is updated based on the context of the first application.
